(19) United States
(12) Patent Application Publication
(10) Pub. No.: US 2025/0205816 A1
(43) Pub. Date: Jun. 26, 2025

(54) LASER PROCESSING MACHINE AND NOZZLE UNIT FOR LASER PROCESING MACHINE

(71) Applicant: KOMATSU INDUSTRIES CORPORATION, Kanazawa-shi, Ishikawa (JP)

(72) Inventors: Yoshihiro YAMAGUCHI, Ishikawa (JP); Nobuhiro TAKATA, Ishikawa (JP); Ninzai CHIYO, Ishikawa (JP); Katsuo SAIO, Ishikawa (JP); Toshiya SHINTANI, Ishikawa (JP)

(21) Appl. No.: 18/847,869

(22) PCT Filed: Apr. 10, 2023
(86) PCT No.: PCT/JP2023/014602

§ 371 Date: Sep. 17, 2024

(30) Foreign Application Priority Data
May 11, 2022 (JP) 2022-078114

(51) Int. Cl. B23K 26/14; B23K 26/03; B23K 26/08

(52) U.S. Cl. CPC B23K 26/147; B23K 26/03; B23K 26/0869

(57) ABSTRACT

A nozzle unit for a laser processing machine includes a first nozzle including a first pathway and blowing port, a second nozzle, a second pathway to pass an inner shielding gas, a second blowing port connected to the second pathway to blow the inner shielding gas toward the workpiece to remove light blocking liquid, a third nozzle, a third pathway to pass an outer shielding gas, and a third blowing port connected to the third pathway to blow out the outer shielding gas toward the workpiece to remove light blocking liquid. The first pathway passes the laser light and an assist gas, the first blowing port is connected to the first pathway to blow out the assist gas toward the workpiece. A height of the third blowing port is greater than a height of the second blowing port, which is greater than a height of the first blowing port.

### CROSS-REFERENCE TO RELATED APPLICATIONS

This application is a U.S. National stage application of International Application No. PCT/JP2023/014602, filed on Apr. 10, 2023. This U.S. National stage application claims priority under 35 U.S.C. § 119(a) to Japanese Patent Application No. 2022-078114, filed in Japan on May 11, 2022, the entire contents of which are hereby incorporated herein by reference.

### BACKGROUND

### Technical Field

The present invention relates to a laser processing machine and a nozzle unit for the same.

### Background Information

The laser processing machine emits a laser light from a nozzle thereof onto a workpiece to perform a variety of processing such as cutting for the workpiece. The laser light, emitted onto the workpiece, is mostly absorbed by the workpiece, whereby the workpiece is melted. However, the laser light is reflected in part by the workpiece and scatters to the surroundings of the workpiece. Because of this, in a laser processing machine described in Publication of Japan Patent No. 5940582, for instance, a cover is provided for inhibiting scattering of the laser light. The cover coves a moving range of the nozzle.

### SUMMARY

In the laser processing machine described above, the cover covers the moving range of the nozzle. Because of this, the laser processing machine is undesirably increased in size. Besides, the laser light penetrates the workpiece and is reflected below the workpiece, whereby the laser light has chances of leaking outside. If the cover is extended to a position below the workpiece to prevent such leakage of the laser light as described above, the laser processing machine is undesirably complicated in structure.

In view of the above, the inventors of the present invention have devised a laser processing machine that a workpiece is disposed in a liquid with light blocking properties (hereinafter referred to as “light blocking liquid”). The light blocking liquid is an aqueous solution that contains, for instance, such an additive as carbon absorbing light. The workpiece is disposed slightly below the liquid surface of the light blocking liquid. Because of this, the surface of the workpiece is covered with the light blocking liquid.

The laser processing machine herein described blows out gas from a nozzle toward the workpiece in processing. Accordingly, the laser processing machine removes the light blocking liquid from the surface of the workpiece and simultaneously processes the workpiece by the laser light. At this time, the surface of the workpiece, excluding a range against which the gas is blown (hereinafter referred to as “processing range”), is covered with the light blocking liquid. Because of this, leakage of the laser light is prevented with a simple structure.

On the other hand, in the laser processing machine described above, when the light blocking liquid enters the processing range on the workpiece, the workpiece is undesirably degraded in quality of processing. Therefore, it is demanded to effectively inhibit the light blocking liquid from entering the processing range on the workpiece. It is an object of the present invention to effectively inhibit a light blocking liquid from entering a processing range on a workpiece in a laser processing machine.

A nozzle unit according to an aspect of the present invention relates to a nozzle unit for a laser processing machine processing a workpiece disposed in a light blocking liquid with light blocking properties by a laser light. The nozzle unit includes a first nozzle, a second nozzle, a second pathway, a second blowing port, a third nozzle, and a third blowing port. The first nozzle includes a first pathway and a first blowing port. The first pathway causes the laser light and an assist gas to pass therethrough. The first blowing port is connected to the first pathway. The first blowing port blows out the assist gas toward the workpiece. The second nozzle is disposed outside the first nozzle. The second pathway is provided between the first nozzle and the second nozzle. The second pathway causes an inner shielding gas to pass therethrough. The second blowing port is connected to the second pathway. The second blowing port blows out the inner shielding gas toward the workpiece to remove the light blocking liquid from a space between the first nozzle and the workpiece. The third nozzle is disposed outside the second nozzle. The third pathway is provided between the second nozzle and the third nozzle. The third pathway causes an outer shielding gas to pass therethrough. The third blowing port is connected to the third pathway. The third blowing port blows out the outer shielding gas toward the workpiece to remove the light blocking liquid from the space between the first nozzle and the workpiece. A height of the third blowing port with respect to the workpiece is greater than a height of the second blowing port with respect to the workpiece. The height of the second blowing port with respect to the workpiece is greater than a height of the first blowing port with respect to the workpiece.

In the nozzle unit according to the present aspect, the gases, blown out from the first to third blowing ports, flow radially outward about the nozzle unit through the space between the workpiece and the nozzle unit. Accordingly; it is made possible to effectively inhibit the light blocking liquid from entering a processing range on the workpiece. Besides, the heights of the first to third blowing ports with respect to the workpiece ascend in this order: the height of the first blowing port, that of the second blowing port, and then that of the third blowing port. Thus, the first to third blowing ports are increased stepwise in position with respect to the workpiece, whereby the gases smoothly flow outward from the center of the nozzle unit. Accordingly; even if droplets exist immediately below the nozzle unit, it is made easy to get the droplets outside by the smoothly flowing gases. As a result, it is made possible to effectively inhibit the light blocking liquid from entering the processing range on the workpiece.

A laser processing machine according to another aspect of the present invention includes a liquid reservoir, a mounting stand, a laser generator, a laser head, a drive device, and the nozzle unit described above.

The liquid reservoir stores the light blocking liquid. The mounting stand is disposed inside the liquid reservoir. The workpiece is mounted on the mounting stand. The laser generator generates the laser light. The laser head is connected to the laser generator. The laser head is disposed above the mounting stand. The drive device moves the laser head. The nozzle unit is attached to the laser head.

In the laser processing machine according to the present aspect, leakage of the laser light is prevented by the light blocking liquid. Besides, with the nozzle unit, it is made possible to effectively inhibit the light blocking liquid from entering the processing range on the workpiece. Because of this, the workpiece is enhanced in quality of processing.

According to the present invention, it is made possible to effectively inhibit a light blocking liquid from entering a processing range on a workpiece in a laser processing machine. Because of this, the workpiece is enhanced in quality of processing.

### BRIEF DESCRIPTION OF THE DRAWINGS

FIG. 1 is a perspective view of a laser processing machine according to an embodiment.

FIG. 2 is a schematic diagram of a configuration of the laser processing machine.

FIG. 3 is a schematic diagram of the configuration of the laser processing machine.

FIG. 4 is a side view of a laser head during cutting of a workpiece.

FIG. 5 is a cross-sectional view of the laser head.

FIG. 6 is a cross-sectional view of a nozzle unit.

FIG. 7 is an enlarged cross-sectional view of the nozzle unit.

FIG. 8 is a cross-sectional view of a first nozzle.

FIG. 9 is a cross-sectional view of a second nozzle.

FIG. 10 is a perspective view of the second nozzle.

FIG. 11 is a cross-sectional view of the nozzle unit taken along line XI-XI in FIG. 7.

FIG. 12 is a view of the second nozzle as seen from the distal end side thereof.

FIG. 13 is a cross-sectional view of a third nozzle.

FIG. 14 is a cross-sectional view of the workpiece and the nozzle unit in cutting of the workpiece.

FIG. 15 is an enlarged cross-sectional view of the nozzle unit in the vicinity of first to third blowing ports.

FIG. 16 is an enlarged cross-sectional view of the nozzle unit in the vicinity of the first to third blowing ports.

FIG. 17 is a cross-sectional view of the laser head during cutting of the workpiece.

FIG. 18 is an enlarged cross-sectional view of a nozzle unit according to a first modification in the vicinity of first to third blowing ports thereof.

FIG. 19 is an enlarged cross-sectional view of a nozzle unit according to a second modification in the vicinity of first to third blowing ports thereof.

FIG. 20 is an enlarged cross-sectional view of a nozzle unit according to a third modification in the vicinity of first to third blowing ports thereof.

### DETAILED DESCRIPTION OF EMBODIMENT(S)

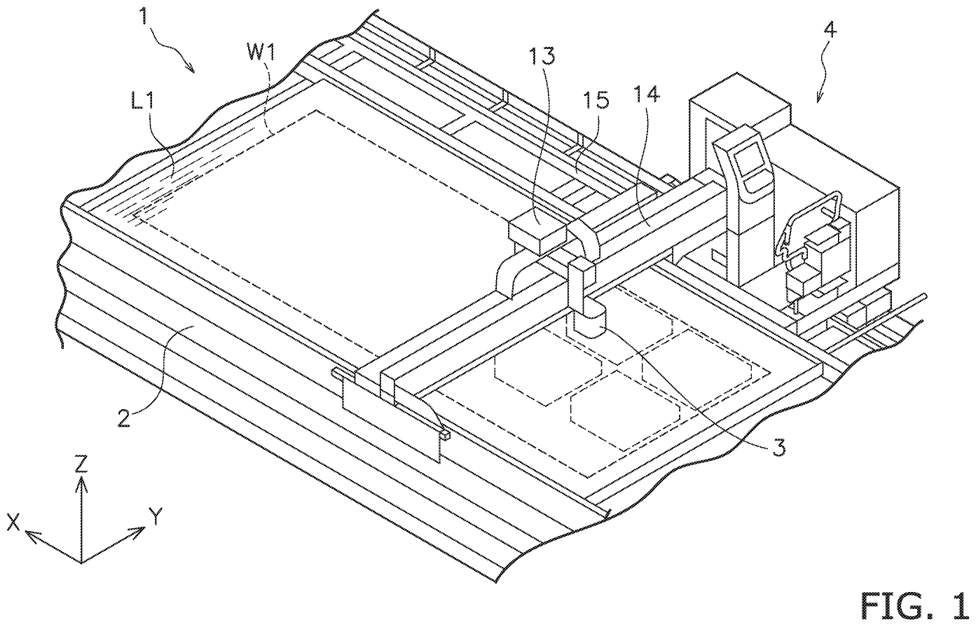

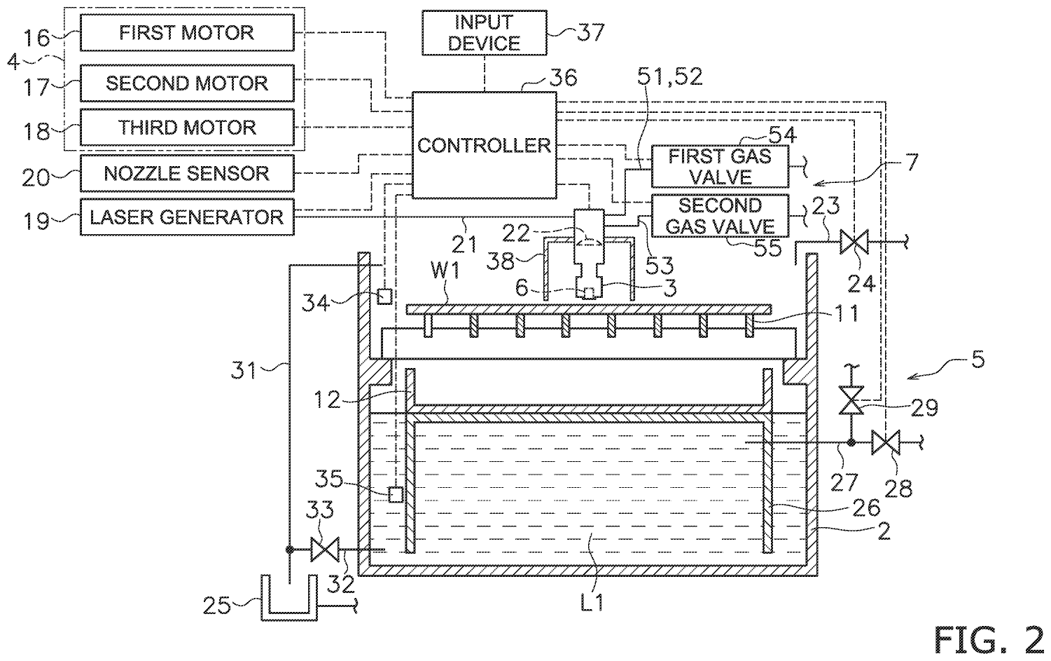

A laser processing machine according to an embodiment will be hereinafter explained with reference to drawings. FIG. 1 is a perspective view of a laser processing machine 1 according to the preferred embodiment. FIG. 2 is a schematic diagram of a configuration of the laser processing machine 1. The laser processing machine 1 is an apparatus for processing a workpiece W1 by a laser light. As shown in FIG. 1, the laser processing machine 1 includes a liquid reservoir 2, a laser head 3, and a drive device 4.

The liquid reservoir 2 stores a light blocking liquid L1 with light blocking properties. The liquid reservoir 2 is made in shape of a box opened upward. As shown in FIG. 2, a mounting stand 11 and a sludge tray 12 are disposed inside the liquid reservoir 2. The workpiece W1 is disposed on the mounting stand 11. The mounting stand 11 includes a plurality of plate members joined to each other in shape of, for instance, a lattice. The sludge tray 12 is disposed below the mounting stand 11. The sludge tray 12 receives sludges to be produced in processing of the workpiece W1 by the laser light.

The drive device 4 moves the laser head 3, while the laser head 3 is disposed above the mounting stand 11. The drive device 4 moves the laser head 3 in a vertical direction (X), a horizontal direction (Y), and an up-and-down direction (Z). The drive device 4 includes a first movable base 13, a second movable base 14, and a support base 15. The first movable base 13 is supported to be movable in the horizontal direction (Y) with respect to the second movable base 14. The laser head 3 is supported to be movable in the up-and-down direction (Z) with respect to the first movable base 13. The second movable base 14 is supported to be movable in the vertical direction (X) with respect to the support base 15. The first movable base 13 is driven in the horizontal direction (Y) by a first motor 16 shown in FIG. 2. The laser head 3 is driven in the up-and-down direction (Z) by a second motor 17. The second movable base 14 is driven in the vertical direction (X) by a third motor 18.

As shown in FIG. 2, the laser processing machine 1 includes a laser generator 19. The laser generator 19 generates the laser light. The laser head 3 is connected to the laser generator 19. The laser generator 19 generates the laser light of, for instance, a fiber laser. The laser light has a wavelength of, for instance, greater than or equal to 0.7 μm and less than or equal to 10 μm. As shown in FIG. 2, the laser head 3 is connected to the laser generator 19 through a fiber cable 21. The laser head 3 includes a condenser lens 22. The laser head 3 concentrates the laser light, generated from the laser generator 19, onto the workpiece W1 by the condenser lens 22.

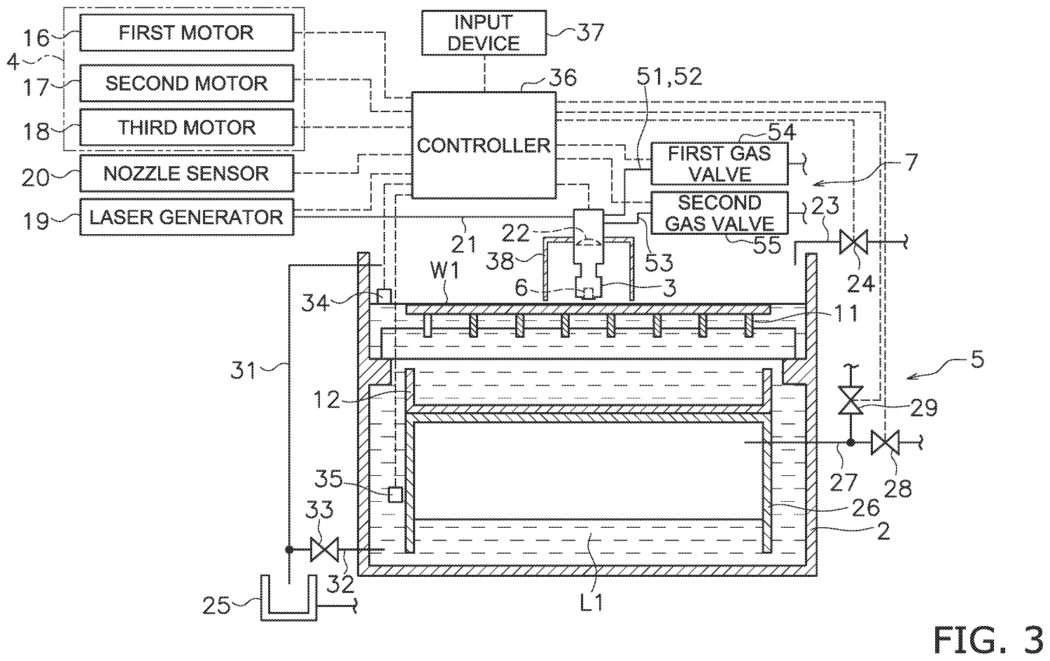

As shown in FIG. 2, the laser processing machine 1 includes a liquid level regulating device 5. The liquid level regulating device 5 changes the height of the liquid surface of the light blocking liquid L1 within the liquid reservoir 2 (hereinafter simply referred to as “liquid level”). The liquid level regulating device 5 is capable of changing the liquid level between a position below the workpiece W1 (see FIG. 2) and a position above the workpiece W1 (see FIG. 3).

The liquid level regulating device 5 includes a feed pipe 23 and a feed valve 24. The feed pipe 23 is connected to an external tank 25 and the liquid reservoir 2. The external tank 25 is disposed outside the liquid reservoir 2. The feed valve 24 is connected to the feed pipe 23. When the feed valve 24 is opened, the light blocking liquid L1 is fed to the liquid reservoir 2 from the external tank 25.

The liquid level regulating device 5 includes a regulation tank 26, a gas pipe 27, a pressurizing valve 28, and a depressurizing valve 29. The interior of the regulation tank 26 is communicated with that of the liquid reservoir 2. The light blocking liquid L1 is enabled to flow from the interior of the regulation tank 26 into that of the liquid reservoir 2. Besides, the light blocking liquid L1 is enabled to flow from the interior of the liquid reservoir 2 to that of the regulation tank 26. The gas pipe 27 connects therethrough the regulation tank 26 and a gas feeding source (not shown in the drawings). The pressurizing valve 28 and the depressurizing valve 29 are connected to the gas pipe 27.

When the pressurizing valve 28 is opened, the gas is supplied to the interior of the regulation tank 26. Accordingly, as shown in FIG. 3, the light blocking liquid L1 is pushed out from the interior of the regulation tank 26 and flows to the interior of the liquid reservoir 2. The liquid level within the liquid reservoir 2 is thereby raised. By contrast, when the depressurizing valve 29 is opened, the gas is discharged to the outside from the interior of the regulation tank 26. Accordingly, as shown in FIG. 2, the light blocking liquid L1 flows from the interior of the liquid reservoir 2 to that of the regulation tank 26. The liquid level within the liquid reservoir 2 is thereby lowered.

The liquid level regulating device 5 includes an overflow pipe 31. The overflow pipe 31 is connected to the liquid reservoir 2 and the external tank 25. When the liquid level within the liquid reservoir 2 reaches a predetermined upper limit of height or greater, the light blocking liquid L1 within the liquid reservoir 2 is discharged to the external tank 25 through the overflow pipe 31.

The liquid level regulating device 5 includes a discharge pipe 32 and a discharge valve 33. The discharge pipe 32 is connected to the liquid reservoir 2 and the external tank 25. The discharge valve 33 is connected to the discharge pipe 32. When the discharge valve 33 is opened, the light blocking liquid L1 is discharged from the liquid reservoir 2 to the external tank 25 through the discharge pipe 32.

The light blocking liquid L1 inhibits transmission of the laser light described above. The transmittance of light with the wavelength band of greater than or equal to 0.7 μm and less than or equal to 10 μm in the light blocking liquid L1 is, for instance, less than or equal to 10%/cm. Preferably, the transmittance of light with the wavelength band of greater than or equal to 0.7 μm and less than or equal to 10 μm in the light blocking liquid L1 is less than or equal to 5%/cm. More preferably, the transmittance of light with the wavelength band of greater than or equal to 0.7 μm and less than or equal to 10 μm in the light blocking liquid L1 is less than or equal to 3%/cm.

In the present preferred embodiment, the light blocking liquid L1 is obtained by dispersing an additive with light blocking properties into an aqueous solution. The additive contains, for instance, carbon black. However, the additive may be another material that exerts high light blocking performance against the laser light. The concentration of carbon black is, for instance, 4.0 to 20.0 weight %. Preferably, the concentration of carbon black is 5.0 to 10.0 weight %.

The laser processing machine 1 includes a liquid level sensor 34 and a transmittance sensor 35. The liquid level sensor 34 detects the liquid level of the light blocking liquid L1 within the liquid reservoir 2. The liquid level sensor 34 outputs a signal indicating the liquid level. The transmittance sensor 35 detects a transmittance of the laser light transmitting through the light blocking liquid L1 within the liquid reservoir 2. The transmittance sensor 35 outputs a signal indicating the transmittance.

The laser processing machine 1 includes a controller 36 and an input device 37. The controller 36 includes a processor such as a CPU and a memory. The controller 36 stores programs and data for controlling the laser processing machine 1. The drive device 4 and the laser generator 19 are controlled by signals transmitted thereto from the controller 36. The feed valve 24, the pressurizing valve 28, and the depressurizing valve 29 are controlled by signals transmitted thereto from the controller 36. The controller 36 receives the signals transmitted from the liquid level sensor 34 and the transmittance sensor 35.

The input device 37 is operable by an operator of the laser processing machine 1. The input device 37 includes, for instance, a switch. The input device 37 may include a touchscreen. The input device 37 may include a port to be connected to an external recording media. The input device 37 may be an external computer. The operator is allowed to input processing conditions with the input device 37. The processing conditions include the plate thickness, the material, the processing speed, the designed shape, and so forth of the workpiece W1. The input device 37 outputs signals indicating the processing conditions to the controller 36.

The controller 36 controls the laser processing machine 1 based on the programs and the processing conditions to cut the workpiece W1 in an intended shape. The controller 36 controls the liquid level regulating device 5 to change the liquid level of the light blocking liquid L1 within the liquid reservoir 2. The controller 36 controls the laser generator 19 to emit the laser light from the laser head 3 onto the workpiece W1. The controller 36 controls the drive device 4 to move the laser head 3, while the laser head 3 is disposed over the workpiece W1.

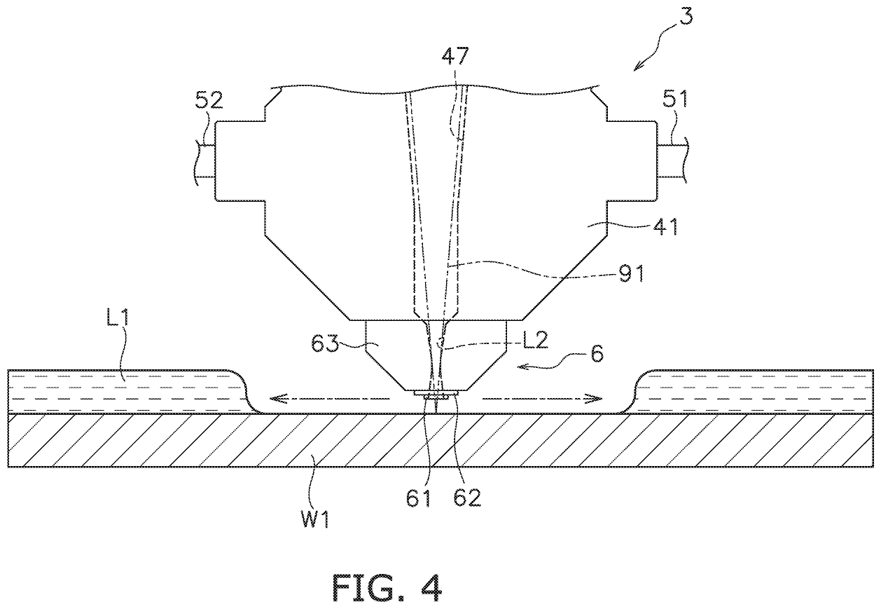

As shown in FIG. 3, the laser processing machine 1 according to the present embodiment processes the workpiece W1, while the liquid level of the light blocking liquid L1 is positioned above the workpiece W1. As shown in FIG. 4, a nozzle unit 6 is attached to the laser head 3. The laser head 3 emits a laser light L2 from the nozzle unit 6 onto the workpiece W1.

Besides, the laser head 3 blows out the gas from the nozzle unit 6 toward the workpiece W1. Accordingly, the light blocking liquid L1 is removed from the surface of the workpiece W1, and simultaneously, the workpiece W1 is processed by the laser light L2. At this time, the workpiece W1, excluding the processing range on the surface thereof, is covered with the light blocking liquid L1. Besides, as shown in FIG. 2, a light blocking cover 38 is attached to the laser head 3. The light blocking cover 38 prevents the laser light from leaking upward from the processing range. The processing range refers to a range, against which the gas is blown, on the surface of the workpiece W1. The processing range includes a point of entry of the laser light L2 on the surface of the workpiece W1. The processing range includes at least a range opposed to the nozzle unit 6.

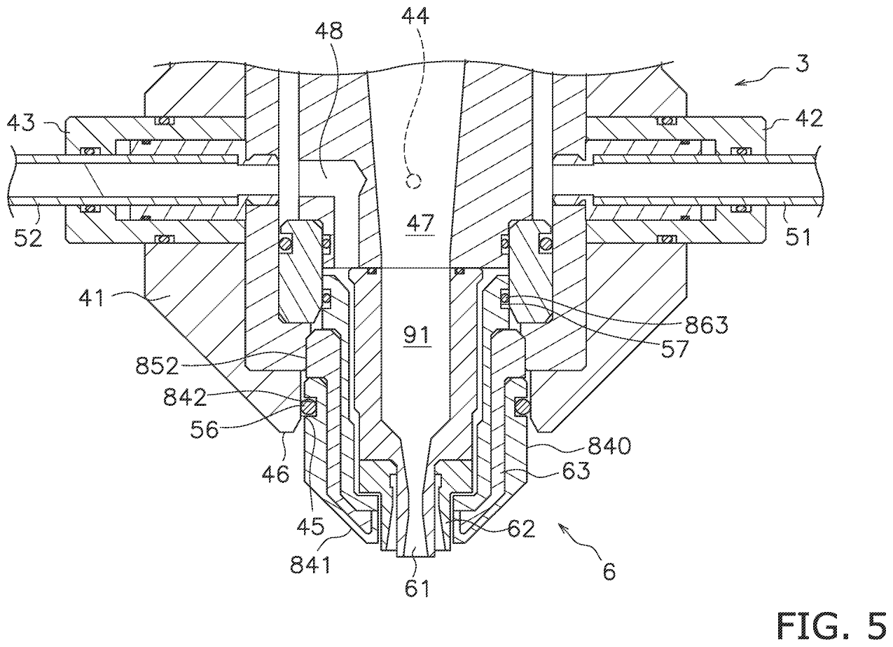

The structure of the laser head 3 and the nozzle unit 6 will be hereinafter explained in detail. The nozzle unit 6 is attached to the distal end of the laser head 3. FIG. 5 is a cross-sectional view of the laser head 3. As shown in FIG. 5, the laser head 3 includes a nozzle pedestal 41, a first gas port 42, a second gas port 43, and a third gas port 44.

The nozzle unit 6 is detachably attached to the nozzle pedestal 41. The nozzle pedestal 41 includes an attachment hole 45. The attachment hole 45 extends upward from a distal end surface 46 of the nozzle pedestal 41. The nozzle unit 6 is disposed in part within the attachment hole 45. The nozzle pedestal 41 includes a laser pathway 47 and a gas pathway 48. The laser pathway 47 extends in the axial direction.

It should be noted that in the following explanation, the term “axial direction” means the axial direction of the nozzle unit 6 and any directions oriented in parallel thereto. The term “radial direction” means the radial direction of the nozzle unit 6 and any directions oriented in parallel thereto. The laser light L2, generated by the laser generator 19, passes through the laser pathway 47. The gas pathway 48 is partitioned off from the laser pathway 47. The gas pathway 48 is disposed radially outside the laser pathway 47.

The first, second, and third gas ports 42, 43, and 44 are connected to the nozzle pedestal 41. The first and second gas ports 42 and 43 are communicated with the gas pathway 48 inside the nozzle pedestal 41. A first gas pipe 51 is connected to the first gas port 42. A second gas pipe 52 is connected to the second gas port 43. The third gas port 44 is communicated with the laser pathway 47 inside the nozzle pedestal 41. A third gas pipe 53, shown in FIG. 2, is connected to the third gas port 44.

As shown in FIG. 2, the laser processing machine 1 includes a gas control device 7. The gas control device 7 controls the gas blown out from the laser head 3. The gas control device 7 includes a first gas valve 54 and a second gas valve 55. The first and second gas valves 54 and 55 are controlled by signals transmitted from the controller 36. The first and second gas pipes 51 and 52 are connected to a gas supply source (not shown in the drawings) through the first gas valve 54. Shielding gas is supplied to the laser head 3 through the first and second gas pipes 51 and 52. The third gas pipe 53 is connected to another gas supply source (not shown in the drawings) through the second gas valve 55. Assist gas is supplied to the laser head 3 via the third gas pipe 53.

When the workpiece W1 made of soft steel or low carbon steel is processed, oxygen, for instance, is used as the assist gas to utilize oxidation-reduction reactions. When the workpiece W1 made of stainless steel is processed, oxidation-reduction reactions cannot be utilized; hence, nitrogen, for instance, is used as the assist gas to prevent oxides from being produced on the cutting surface of the workpiece W1. On the other hand, the shielding gas is used for removing the light blocking liquid L1 from the surfaces of the workpiece W1; hence, low-cost compressed air, for instance, is used as the shielding gas.

The nozzle unit 6 is detachably attached to the laser head 3. In other words, the nozzle unit 6 is attached to the laser head 3 in a replaceable manner. It should be noted that in the following explanation of the nozzle unit 6, a direction oriented from the base end to the distal end in the nozzle unit 6 is defined as a downward direction. Contrarily, a direction oriented from the distal end to the base end in the nozzle unit 6 is defined as an upward direction.

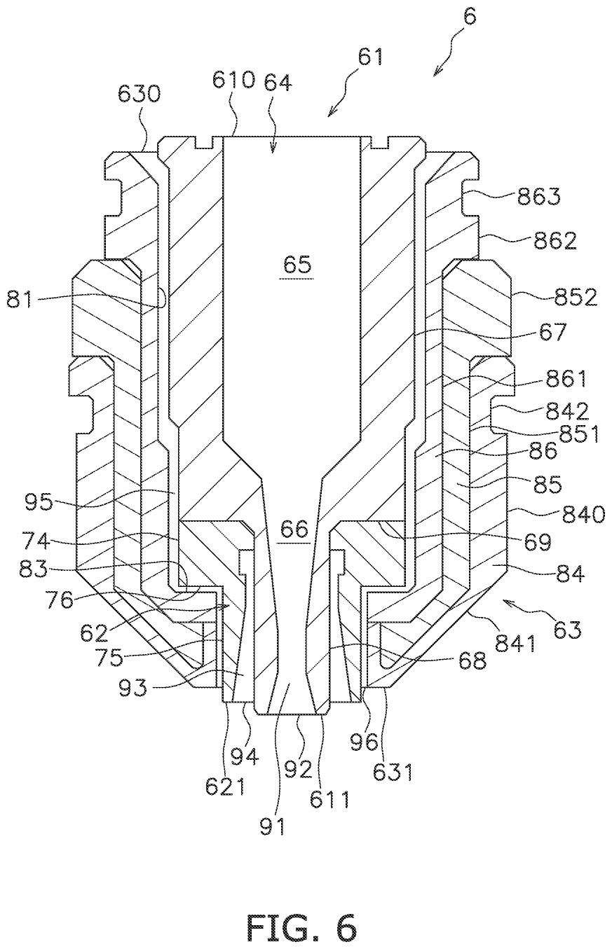

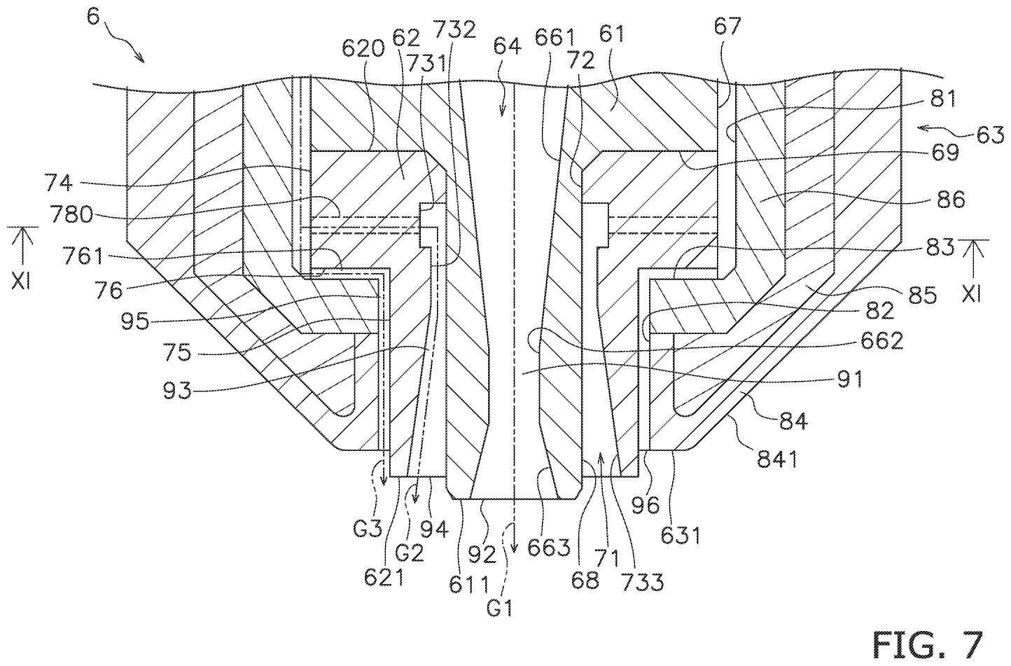

The distal end of the nozzle unit 6 means an end that is one of the ends of the nozzle unit 6 in the axial direction and faces the workpiece W1. The base end of the nozzle unit 6 is located on the opposite side of the distal end thereof in the axial direction of the nozzle unit 6. FIG. 6 is a cross-sectional view of the nozzle unit 6. FIG. 7 is an enlarged cross-sectional view of the nozzle unit 6. The nozzle unit 6 includes a first nozzle 61, a second nozzle 62, and a third nozzle 63.

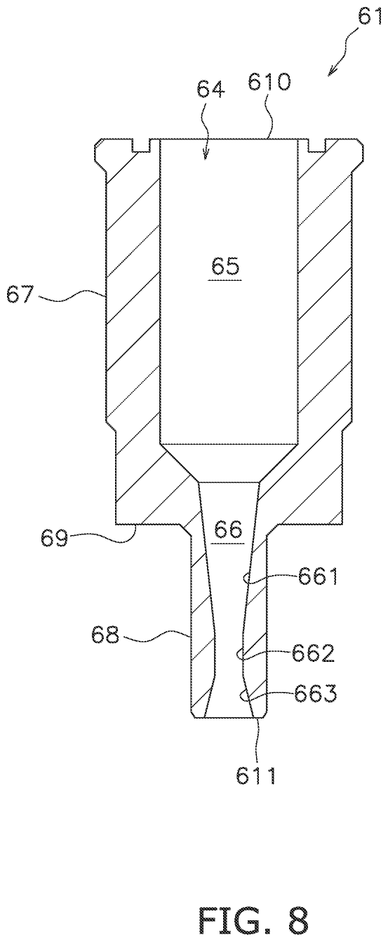

FIG. 8 is a cross-sectional view of the first nozzle 61. The first nozzle 61 is made of metal with electrical conductivity. For example, the first nozzle 61 is made of copper. However, the first nozzle 61 may be made of metal other than copper. The first nozzle 61 includes a first through hole 64. The first through hole 64 penetrates the first nozzle 61 in the axial direction.

The first through hole 64 includes a body hole portion 65 and a first de Laval nozzle portion 66. The body hole portion 65 extends downward from a base end 610 of the first nozzle 61. The body hole portion 65 extends straight in the axial direction. The first de Laval nozzle portion 66 extends upward from a distal end 611 of the first nozzle 61. The first de Laval nozzle portion 66 includes a first inlet portion 661, a first intermediate portion 662, and a first outlet portion 663. The first de Laval nozzle portion 66 is shaped to be narrowed at the first intermediate portion 662.

The first inlet portion 661 is connected to the body hole portion 65. The first inlet portion 661 is smaller in inner diameter than the body hole portion 65. The first inlet portion 661 slants to be reduced in radial dimension toward the distal end 611 of the first nozzle 61. The first intermediate portion 662 is located between the first inlet portion 661 and the first outlet portion 663. The first outlet portion 663 is connected to the distal end 611 of the first nozzle 61. The first outlet portion 663 slants to be increased in radial dimension toward the distal end 611 of the first nozzle 61.

The first nozzle 61 includes a first body 67, a first distal end portion 68, and a first step portion 69 on the outer surface thereof. The first body 67 is larger in outer diameter than the first distal end portion 68. The first body 67 extends downward from the base end 610 of the first nozzle 61. The first distal end portion 68 protrudes downward from the first body 67. The first distal end portion 68 extends upward from the distal end 611 of the first nozzle 61. The first step portion 69 is provided between the first body 67 and the first distal end portion 68.

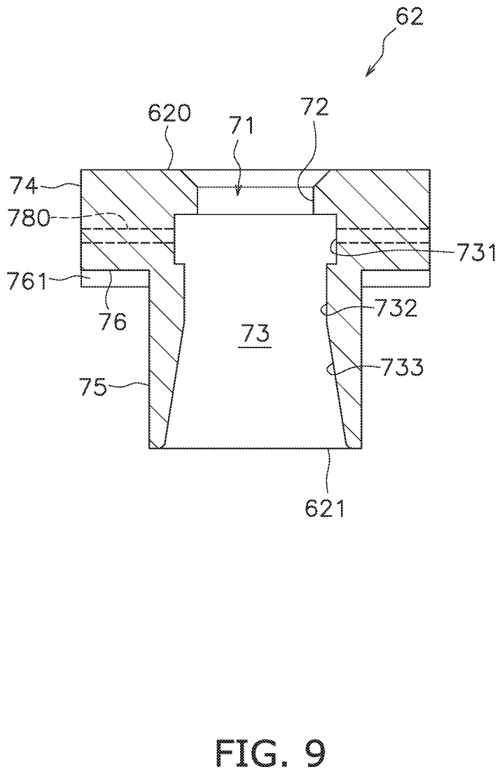

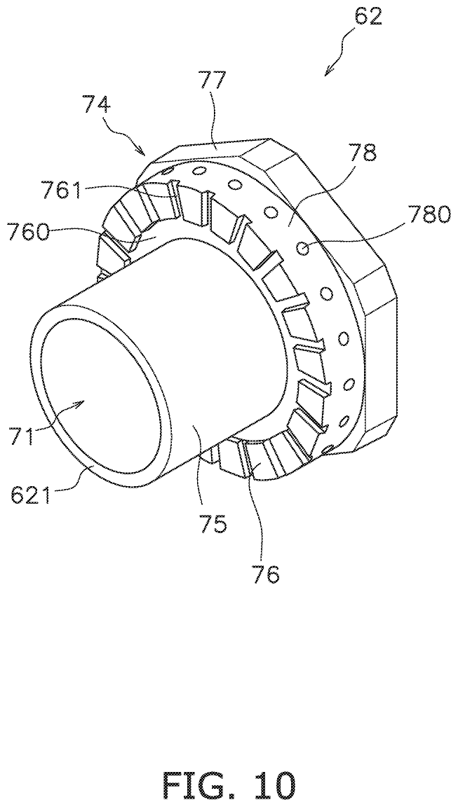

The second nozzle 62 is disposed outside the first nozzle 61. The second nozzle 62 is made of an insulator. For example, the second nozzle 62 is made of a ceramic material. Alternatively, the second nozzle 62 may be made of another insulator such as resin. FIG. 9 is a cross-sectional view of the second nozzle 62. FIG. 10 is a perspective view of the second nozzle 62.

The second nozzle 62 includes a second through hole 71. The second through hole 71 penetrates the second nozzle 62 in the axial direction. The first distal end portion 68 of the first nozzle 61 is disposed inside the second through hole 71. As shown in FIG. 9, the second through hole 71 includes a nozzle joined portion 72 and a second de Laval nozzle portion 73.

The nozzle joined portion 72 extends downward from a base end 620 of the second nozzle 62. The nozzle joined portion 72 is chamfered at the edge thereof. The nozzle joined portion 72 is fixed to the first distal end portion 68 of the first nozzle 61. The nozzle joined portion 72 is fixed onto the first distal end portion 68 by, for instance, press-fitting. Alternatively, the nozzle joined portion 72 may be fixed to the first distal end portion 68 by another fixation means such as screwing using threads. The nozzle joined portion 72 is in contact with the first distal end portion 68. Accordingly, the first distal end portion 68 and the nozzle joined portion 72 are sealed therebetween.

The second de Laval nozzle portion 73 is connected to the nozzle joined portion 72. The second de Laval nozzle portion 73 extends upward from a distal end 621 of the second nozzle 62. The second de Laval nozzle portion 73 includes a second inlet portion 731, a second intermediate portion 732, and a second outlet portion 733. The second de Laval nozzle portion 73 is shaped to be narrowed at the second intermediate portion 732.

The second inlet portion 731 is connected to the nozzle joined portion 72. The second inlet portion 731 is larger in inner diameter than the nozzle joined portion 72. The second intermediate portion 732 is connected to the second inlet portion 731. The second intermediate portion 732 is smaller in inner diameter than the second inlet portion 731. The second outlet portion 733 is connected to the second intermediate portion 732. The second outlet portion 733 extends upward from the distal end 621 of the second nozzle 62. The second outlet portion 733 slants to be increased in radial dimension toward the distal end 621 of the second nozzle 62.

The second nozzle 62 includes a second body 74, a second distal end portion 75, and a second step portion 76 on the outer surface thereof. The second body 74 extends downward from the base end 620 of the second nozzle 62. As shown in FIG. 10, the second body 74 includes a prismatic portion 77 and a tubular portion 78. The prismatic portion 77 is made in shape of a polygonal prism. The prismatic portion 77 is chamfered at the edges thereof. In the present embodiment, the prismatic portion 77 is made in shape of a hexagonal prism. However, the prismatic portion 77 may be made in shape of another prism.

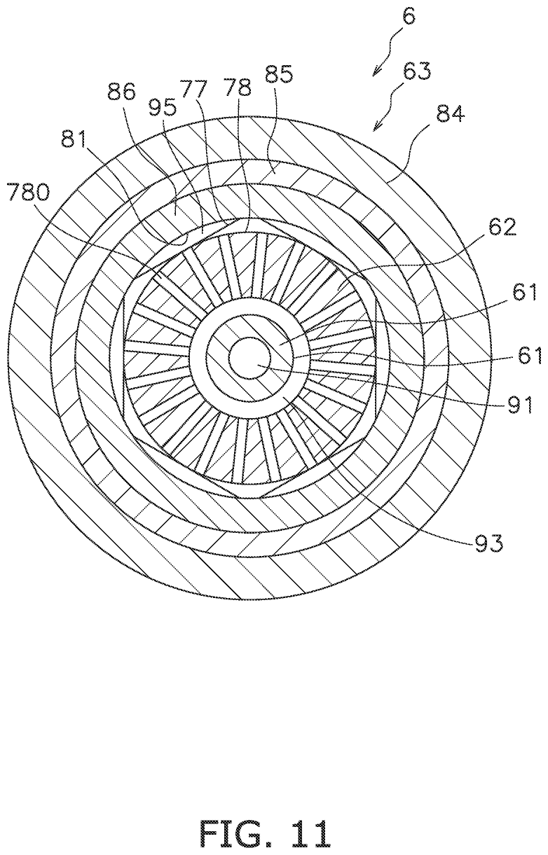

FIG. 11 is a cross-sectional view of the nozzle unit 6 taken along line XI-XI in FIG. 7. The tubular portion 78 is smaller in outer diameter than the length of a diagonal the prismatic portion 77. The tubular portion 78 is equal in outer diameter to the distance of each pair of opposed sides of the prismatic portion 77. However, the tubular portion 78 may be smaller in outer diameter than the distance of each pair of opposed sides of the prismatic portion 77. The tubular portion 78 is larger in outer diameter than the second distal end portion 75. The second distal end portion 75 protrudes downward from the tubular portion 78. The second distal end portion 75 extends upward from the distal end 621 of the second nozzle 62. The second step portion 76 is provided between the second body 74 and the second distal end portion 75.

The second nozzle 62 includes a plurality of holes 780. The plural holes 780 each extend in the radial direction from the second through hole 71 of the second nozzle 62 to the outer surface of the second nozzle 62. The plural holes 780 extend from the second through hole 71 of the second nozzle 62 in a radial shape. When described in detail, the plural holes 780 extend from the second inlet portion 731 of the second nozzle 62 to the tubular portion 78. The plural holes 780 are disposed to be offset (displaced) from the center of the second nozzle 62. Alternatively; the plural holes 780 may each slant with respect to the radial direction. It should be noted that in the drawings, reference sign 780 is assigned to only a part of the plural holes 780 without being assigned to the remainder of the plural holes 780.

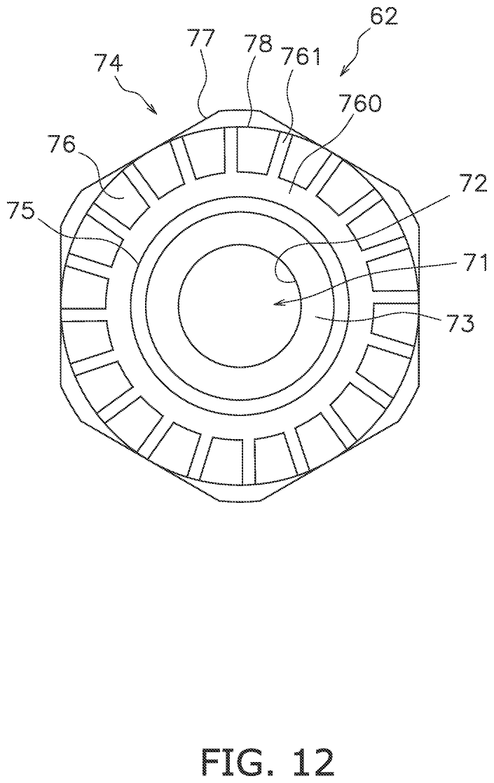

FIG. 12 is a view of the second nozzle 62 seen from the distal end side thereof. As shown in FIG. 12, the second nozzle 62 includes an annular groove 760 and a plurality of grooves 761. The annular groove 760 and the plural grooves 761 are provided on the second step portion 76. The annular groove 760 is disposed in the surroundings of the second distal end portion 75. The plural grooves 761 each extend in the radial direction from the annular groove 760 to the outer surface of the second nozzle 62. The plural grooves 761 extend from the annular groove 760 in a radial shape. When described in detail, the plural grooves 761 extend from the annular groove 760 to the tubular portion 78. The plural grooves 761 are disposed to be offset (displaced) from the center of the second nozzle 62. Alternatively; the plural grooves 761 may each slant with respect to the radial direction. It should be noted that in the drawings, reference sign 761 is assigned to only a part of the plural grooves 761 without being assigned to the remainder of the plural grooves 761.

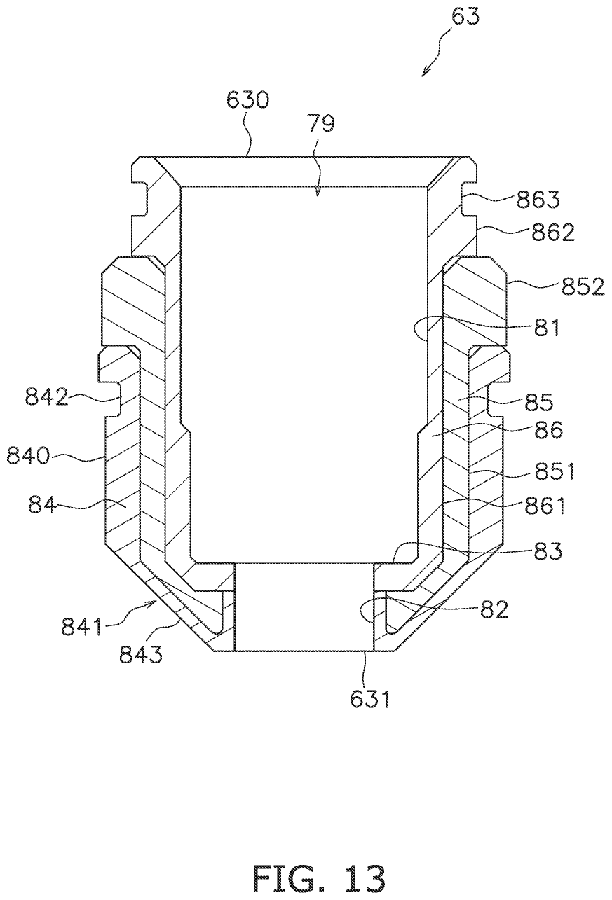

The third nozzle 63 is disposed outside the second nozzle 62. FIG. 13 is a cross-sectional view of the third nozzle 63. As shown in FIG. 13, the third nozzle 63 includes a third through hole 79. The third through hole 79 penetrates the third nozzle 63 in the axial direction. The first and second nozzles 61 and 62 are disposed inside the third through hole 79. The third through hole 79 includes a third inlet portion 81, a third outlet portion 82, and a third step portion 83. The third inlet portion 81 extends downward from a base end 630 of the third nozzle 63. The third outlet portion 82 extends upward from a distal end 631 of the third nozzle 63. The third outlet portion 82 is smaller in inner diameter than the third inlet portion 81. The third step portion 83 is provided between the third inlet portion 81 and the third outlet portion 82.

The third nozzle 63 includes an outer cap 84, a shield 85, and an insulating guide 86. The shield 85, the outer cap 84, and the insulating guide 86 are integrated with each other. The shield 85, the outer cap 84, and the insulating guide 86 are joined to each other by; for instance, press-fitting or adhesion. Alternatively; the shield 85, the outer cap 84, and the insulating guide 86 may be joined to each other by screwing using threads.

The outer cap 84 is made of an insulator such as a ceramic material. However, the outer cap 84 may be made of another insulator such as resin. The outer cap 84 includes a cap body 840 and a cap distal end portion 841. The cap body 840 has a tubular shape. The cap body 840 is disposed in part inside the attachment hole 45 of the nozzle pedestal 41.

The cap body 840 includes a first recessed groove 842. The first recessed groove 842 circumferentially extends on the outer peripheral surface of the cap body 840. A first O-ring 56, shown in FIG. 5, is disposed in the first recessed groove 842. The cap body 840 and the attachment hole 45 are sealed therebetween by the first O-ring 56. The light blocking liquid L1 is prevented from entering the interior of the laser head 3 by the first O-ring 56.

The cap distal end portion 841 includes a taper surface 843 that slants to be reduced in radial dimension toward the distal end 631. The edge between the taper surface 843 and the distal end 631 is rounded to become smooth. The cap distal end portion 841 is exposed to the outside of the laser head 3. The cap distal end portion 841 is disposed on the outer peripheral side of the second distal end portion 75 of the second nozzle 62.

The shield 85 is disposed inside the outer cap 84. The shield 85 is made of metal with electrical conductivity. For example, the shield 85 is made of brass. However, the shield 85 may be made of metal other than brass.

The shield 85 includes a shield body 851 and a unit joined portion 852. The shield body 851 is disposed inside the outer cap 84. The unit joined portion 852 protrudes upward from the outer cap 84. The unit joined portion 852 is disposed to be exposed to the outside of the nozzle unit 6. The nozzle unit 6 is attached at the unit joined portion 852 to the nozzle pedestal 41. For example, the unit joined portion 852 is provided with male threads, whereas the attachment hole 45 is provided with female threads. The male threads of the unit joined portion 852 are screwed into the female threads of the attachment hole 45. Accordingly, the nozzle unit 6 is fixed to the nozzle pedestal 41.

The insulating guide 86 is disposed inside the shield 85. The insulating guide 86 is disposed between the shield 85 and both the first and second nozzles 61 and 62. The insulating guide 86 is disposed outside the first and second nozzles 61 and 62. The shield 85 is covered with the outer cap 84 and the insulating guide 86. The insulating guide 86 is made of a material with electrical insulation such as resin. Alternatively, the insulating guide 86 may be made of another insulating material such as a ceramic material.

The insulating guide 86 includes a guide body 861 and a guide seal portion 862. The guide body 861 is disposed inside the shield 85. The guide seal portion 862 protrudes upward from the shield 85. The guide seal portion 862 is disposed to be exposed to the outside of the nozzle unit 6. The guide seal portion 862 includes a second recessed groove 863 on the outer peripheral surface thereof. The second recessed groove 863 circumferentially extends on the outer peripheral surface of the guide seal portion 862. A second O-ring 57, shown in FIG. 5, is disposed in the second recessed groove 863. The third nozzle 63 and the attachment hole 45 are sealed therebetween by the second O-ring 57. Leakage of the shielding gas is prevented by the second O-ring 57.

As shown in FIGS. 6 and 7, the nozzle unit 6 includes a first pathway 91 and a first blowing port 92. The first pathway 91 is formed by the first through hole 64 of the first nozzle 61. As shown in FIG. 5, the first pathway 91 is connected to the laser pathway 47 inside the nozzle pedestal 41. The first blowing port 92 is connected to the first pathway 91. The first blowing port 92 is provided in the distal end 611 of the first nozzle 61.

The nozzle unit 6 includes a second pathway 93 and a second blowing port 94. The second pathway 93 is provided between the first nozzle 61 and the second nozzle 62. When described in detail, the second pathway 93 is provided between the first distal end portion 68 of the first nozzle 61 and the following portions of the second nozzle 62: the second inlet portion 731, the second intermediate portion 732, and the second outlet portion 733. The second pathway 93 has an annular shape. The second blowing port 94 is connected to the second pathway 93. The second blowing port 94 is provided in the distal end 621 of the second nozzle 62.

The nozzle unit 6 includes a third pathway 95 and a third blowing port 96. The third pathway 95 is provided not only between the first nozzle 61 and the third nozzle 63 but also between the second nozzle 62 and the third nozzle 63. The third pathway 95 has an annular shape. When described in detail, the third pathway 95 is provided between the first body 67 of the first nozzle 61 and the third inlet portion 81 of the third nozzle 63. The third pathway 95 is provided between the second body 74 and the third inlet portion 81. As shown in FIG. 11, the prismatic portion 77 is in contact at the edges thereof with the third inlet portion 81. The third pathway 95 is provided in gaps between the lateral surfaces of the prismatic portion 77 and the third inlet portion 81. The third pathway 95 is provided between the plural grooves 761 of the second nozzle 62 and the third step portion 83. The third pathway 95 is provided between the second distal end portion 75 and the third outlet portion 82. The third blowing port 96 is connected to the third pathway 95. The third blowing port 96 is provided in the distal end 631 of the third nozzle 63. The second pathway 93 is communicated with the third pathway 95 through the plural holes 780 of the second nozzle 62.

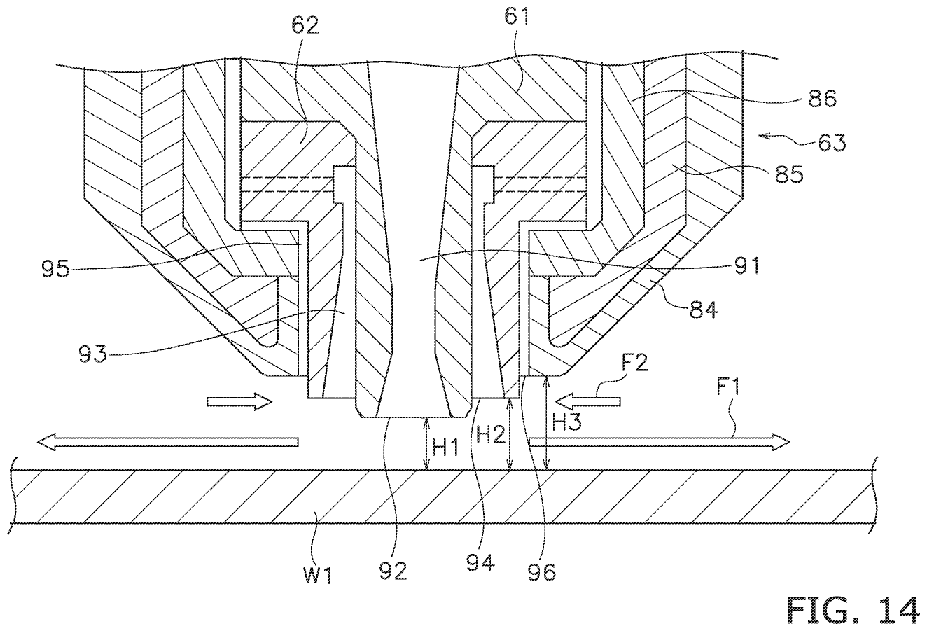

The first blowing port 92 further protrudes downward than the second blowing port 94. The second blowing port 94 further protrudes downward than the third blowing port 96. FIG. 14 is a diagram showing the workpiece W1 and the nozzle unit 6 in cutting of the workpiece W1. As shown in FIG. 14, the height (H3) of the third blowing port 96 with respect to the workpiece W1 is greater than the height (H2) of the second blowing port 94 with respect to the workpiece W1. The height (H2) of the second blowing port 94 with respect to the workpiece W1 is greater than the height (H1) of the first blowing port 92 with respect to the workpiece W1.

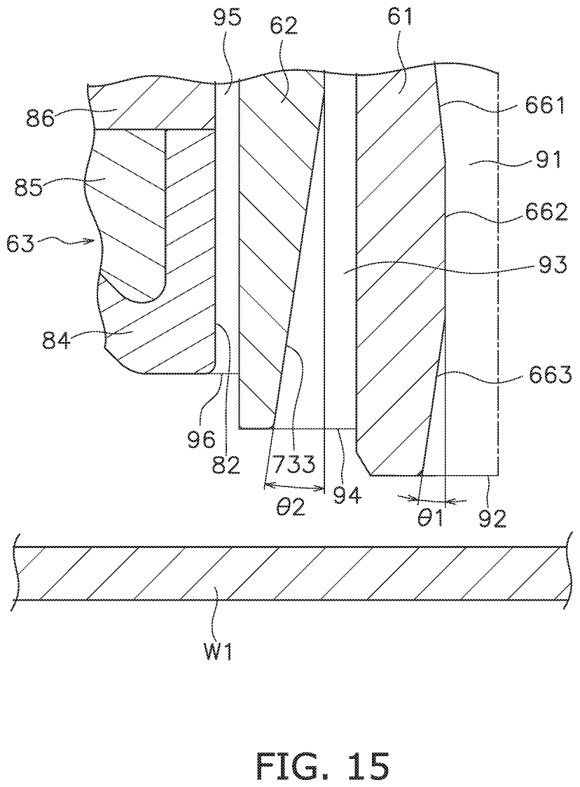

FIG. 15 is an enlarged cross-sectional view of the nozzle unit 6 in the vicinity of the first to third blowing ports 92, 94, and 96. As shown in FIG. 15, the slant angle (θ2) of the second outlet portion 733 with respect to the axial direction is greater than the slant angle (θ1) of the first outlet portion 663 with respect to the axial direction. The third outlet portion 82 extends straight in the axial direction. In other words, the slant angle of the third outlet portion 82 is 0 degrees.

The laser light L2, generated by the laser generator 19, enters the first pathway 91 from the laser pathway 47. The laser light L2 passes through the first pathway 91 and is emitted from the first blowing port 92 toward the workpiece W1. On the other hand, the assist gas enters the first pathway 91 from the laser pathway 47. As shown in FIG. 7, the assist gas (G1) passes through the first pathway 91 and is blown out from the first blowing port 92 toward the workpiece W1.

The shielding gas enters the third pathway 95 from the gas pathway 48. The shielding gas enters in part the second pathway 93 as inner shielding gas (G2) from the third pathway 95 through the plural holes 780 of the second nozzle 62. While passing through the plural holes 780, the inner shielding gas (G2) forms a swirl flow. The inner shielding gas (G2) passes through the second pathway 93 and is blown out from the second blowing port 94 toward the workpiece W1. The remainder of the shielding gas passes through the third pathway 95 as outer shielding gas (G3). While passing through the plural grooves 761, the outer shielding gas (G3) forms a swirl flow. The outer shielding gas (G3) is blown out from the third blowing port 96 toward the workpiece W1.

As shown in FIG. 2, the laser processing machine 1 includes a nozzle sensor 20. The nozzle sensor 20 detects the height of the first nozzle 61 with respect to the workpiece W1. When described in detail, the nozzle sensor 20 detects a capacitance between the first nozzle 61 and the workpiece W1. The controller 36 calculates the height of the first nozzle 61 with respect to the workpiece W1 based on the capacitance. The controller 36 controls the drive device 4 to move the laser head 3 in a height direction based on the height of the first nozzle 61. Explanation regarding controlling the laser processing machine 1 by the controller 36 is as follows.

First, as shown in FIG. 2, the workpiece W1 is mounted to the mounting stand 11, while the liquid level of the light blocking liquid L1 is below the mounting stand 11. When receiving a command of starting processing from the input device 37, the controller 36 controls the liquid level regulating device 5 to raise the liquid level of the light blocking liquid L1. As shown in FIG. 3, the controller 36 raises the liquid level to a predetermined position above the workpiece W1. Accordingly, the workpiece W1 is immersed in the light blocking liquid L1. For example, the liquid level in processing is located above the workpiece W1 by several mm to more than 10 mm. It should be noted that the controller 36 obtains the liquid level based on the signal outputted from the liquid level sensor 34. The controller 36 detects the transmittance through the light blocking liquid L1 based on the signal outputted from the transmittance sensor 35.

Next, the controller 36 controls the drive device 4 to move the laser head 3 to a position located above a position for starting processing on the workpiece W1. When the laser head 3 reaches the position located above the position for starting processing, the controller 36 lowers the laser head 3 toward the workpiece W1, and simultaneously, controls the gas control device 7 to blow out the assist gas G1, the inner shielding gas G2, and the outer shielding gas G3 from the nozzle unit 6. Accordingly, the assist gas G1 and the shielding gases G2 and G3 are blown against the surface of the workpiece W1, whereby the light blocking liquid L1 is removed from the processing range on the surface of the workpiece W1 as shown in FIG. 4.

At this time, the inner shielding gas G2 blown out from the second blowing port 94 is larger in flow rate than the outer shielding gas G3 blown out from the third blowing port 96. On the other hand, the assist gas G1 blown out from the first blowing port 92 is larger in flow rate than the inner shielding gas G2 blown out from the second blowing port 94.

The controller 36 obtains the height of the first nozzle 61 from the workpiece W1 based on a signal outputted thereto from the nozzle sensor 20. The controller 36 lowers the first nozzle 61 to a predetermined height position located above the workpiece W1. The controller 36 starts processing the workpiece W1 by the laser light L2 based on the processing conditions. The controller 36 controls the laser generator 19 to emit the laser light L2 from the laser head 3 onto the workpiece W1 in order to cut the workpiece W1. The controller 36 controls the drive device 4 to move the laser head 3 in both the vertical direction (X) and the horizontal direction (Y). Accordingly; the workpiece W1 is cut in a shape determined based on the processing conditions. It should be noted that, when the transmittance through the light blocking liquid L1 is greater than or equal to a predetermined threshold, the controller 36, even if receiving a command of starting processing, may issue an alert without starting processing.

When the processing of the workpiece W1 has been completed, the controller 36 stops emission of the laser light L2 and blowing out of the gases. Besides, the controller 36 elevates the laser head 3 to move the laser head 3 to a predetermined standby position. The controller 36 lowers the liquid level of the light blocking liquid L1 to a height position located below the workpiece W1. Accordingly; the workpiece W1, processed by cutting, is enabled to be transported from the mounting stand 11.

In the laser processing machine 1 according to the present embodiment explained above, the gases blown out from the first to third blowing ports 92, 94, and 96 flow radially outward about the nozzle unit 6 through the space between the workpiece W1 and the nozzle unit 6. Accordingly; it is made possible to effectively inhibit the light blocking liquid from entering the processing range on the workpiece W1.

As shown in FIG. 14, the heights H3 of the first to third blowing ports 92, 94, and 96 with respect to the workpiece W1 ascend in this order: the height of the first blowing port 92, that of the second blowing port 94, and then that of the third blowing port 96. In other words, the first to third blowing ports 92, 94, and 96 are increased stepwise in position with respect to the workpiece W1. Because of this, the assist gas G1 and the shielding gases G2 and G3 generate a gas flow F1 smoothly flowing outward from the center of the nozzle unit 6 along the workpiece W1. Accordingly, even if droplets exist immediately below the nozzle unit 6, it is made easy to get the droplets outward by the gas flow F1. Therefore, attachment of droplets to the first nozzle 61 can be inhibited. As a result, change in capacitance of the first nozzle 61 due to attachment of droplets can be inhibited, whereby erroneous detection of the height of the first nozzle 61 can be inhibited.

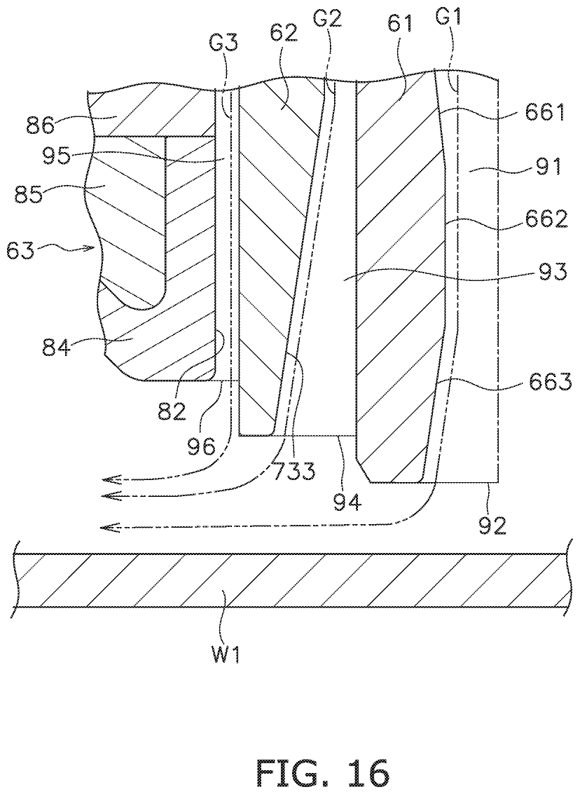

The first outlet portion 663 slants with respect to the axial direction. Accordingly, as shown in FIG. 16, the assist gas G1 flows along the first outlet portion 663; hence, the assist gas G1 does not easily separate from the first outlet portion 663, while flowing thereon. The second outlet portion 733 slants with respect to the axial direction. Accordingly, the inner shielding gas G2 flows along the second outlet portion 733; hence, the inner shielding gas G2 does not easily separate from the second outlet portion 733, while flowing thereon.

Besides, the slant angle θ2 of the second outlet portion 733 with respect to the axial direction is larger than the slant angle θ1 of the first outlet portion 663 with respect to the axial direction. Accordingly, as shown in FIG. 14, the gas flow F1 smoothly flows outward from the center of the nozzle unit 6. Therefore, even if droplets exist immediately below the nozzle unit 6, it is made easy to get the droplets outward by the gas flow F1. Besides, a vortex flow of gas is likely to be generated immediately below the nozzle unit 6 by the assist gas G1 and the shielding gases G2 and G3. Albeit droplets are directed from the inner peripheral side to the outer peripheral side of the nozzle unit 6 on the surface of the workpiece W1, the vortex flow of gas flows to lift upward the droplets to return the droplets to the inner peripheral side of the nozzle unit 6. However, in the laser processing machine 1 according to the present embodiment, the assist gas G1 and the shielding gases G2 and G3 are inhibited from generating the vortex flow of gas immediately below the nozzle unit 6. Because of this, it is made difficult for the droplets to enter the space immediately below the nozzle unit 6. For example, the slant angle θ1 of the first outlet portion 663 with respect to the axial direction is less than three degrees. The slant angle θ2 of the second outlet portion 733 with respect to the axial direction is less than nine degrees.

The inner shielding gas G2 blown out from the second blowing port 94 is larger in flow rate than the outer shielding gas G3 blown out from the third blowing port 96. Besides, the assist gas G1 blown out from the first blowing port 92 is larger in flow rate than the inner shielding gas G2 blown out from the second blowing port 94. For example, the assist gas G3 flows at a flow rate of 120 m/s; the inner shielding gas G2 flows at a flow rate of 75 m/s; the outer shielding gas G3 flows at a flow rate of 50 m/s. Accordingly, it is made possible to, for instance, inhibit the droplets from being blown up in the vicinity of the edges of the workpiece W1 processed by cutting.

The third nozzle 63 includes the taper surface 843. Because of this, a space immediately below the third nozzle 63 is increased in size than that immediately below the third nozzle 63 not including the taper surface 843. For example, the slant angle of the taper surface 843 with respect to the horizontal direction is greater than 45 degrees. Accordingly, as shown in FIG. 14, a gas flow F2, reversely flowing along the surface of the third nozzle 63, is reduced in speed. As a result, the gas flow F2 flowing reversely can be inhibited from causing droplets to enter the space immediately below the nozzle unit 6.

In the third nozzle 63, the edge between the taper surface 843 and the distal end 631 is rounded. For example, the edge is rounded with a radius of greater than one mm. Accordingly, steep change in speed of the gas flow F2 flowing reversely can be inhibited at the edge between the taper surface 843 and the distal end 631 of the third nozzle 63. As a result, the gas flow F2 flowing reversely can be inhibited from causing droplets to enter the space immediately below the nozzle unit 6.

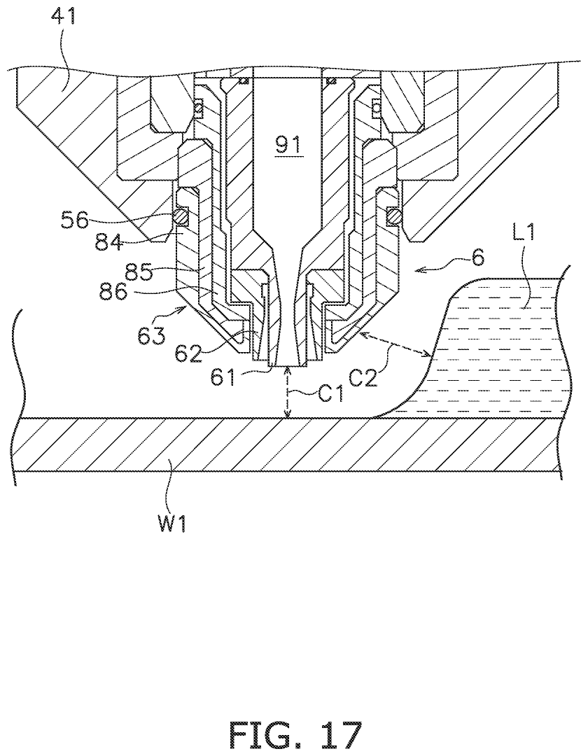

The third nozzle 63 has a triple nesting structure composed of the outer cap 84, the shield 85, and the insulating guide 86. As shown in FIG. 17, with the shield 85, change in the capacitance C2 due to change in position of the light blocking liquid L1 can be inhibited from being erroneously detected as change in capacitance C1 between the first nozzle 61 and the workpiece W1. Besides, the shield 85 is covered with the outer cap 84 and the insulating guide 86, each of which is of an insulator. Because of this, attachment of droplets to the shield 85 can be inhibited. As a result, erroneous detection of the height of the first nozzle 61 can be inhibited.

Besides, the outer cap 84 is made of a ceramic material and is thereby enhanced in endurance against spatters generated in cutting by the laser. The insulating guide 86 is made of resin and is thereby enhanced in adhesiveness to the nozzle pedestal 41. Accordingly, leakage of the shielding gas can be inhibited.

One embodiment of the present invention has been explained above. However, the present invention is not limited to this, and a variety of changes can be made without departing from the gist of the present invention.

The laser processing machine 1 is not limited in configuration to the embodiment described above and may be changes. For example, in the embodiment described above, the laser processing machine 1 executes cutting of the workpiece W1 by the laser light. However, the laser processing machine 1 may execute welding of the workpiece W1 by the laser light.

The laser generator 19 is not limited to the fiber laser but may be another type of laser such as a solid-state laser (e.g., YAG laser) or a carbon dioxide laser. The liquid level regulating device 5 is not limited in configuration to the embodiment described above and may be changed. For example, the liquid level regulating device 5 may change the liquid level by controlling the amount of the light blocking liquid L1 to be supplied to the liquid reservoir 2.

The nozzle unit 6 is not limited in configuration to the embodiment described above and may be changed. For example, the respective parts of the nozzle unit 6 are exemplified as having such dimensions as described above but are not limited in dimension to the above.

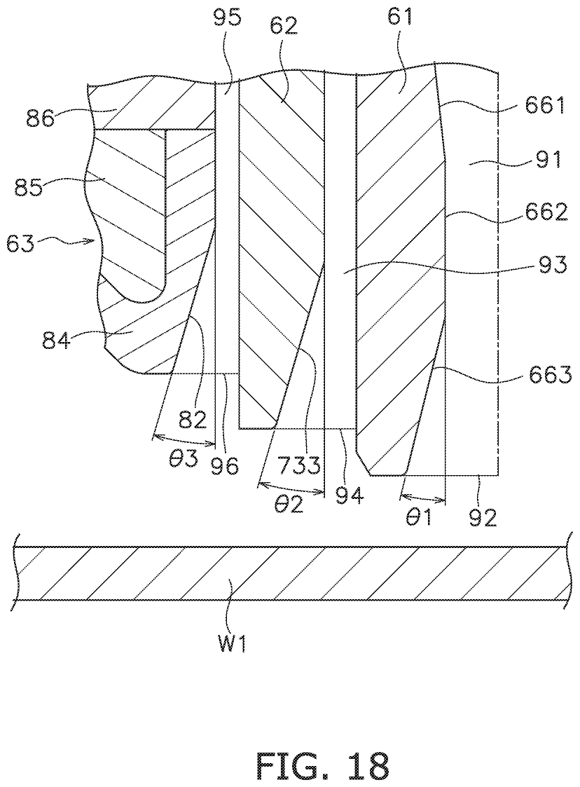

In the embodiment described above, the slant angle of the third outlet portion 82 of the third pathway 95 is 0 degrees. However, the third outlet portion 82 may slant with respect to the axial direction as configured in a first modification shown in FIG. 18. For example, the slant angle (θ3) of the third outlet portion 82 with respect to the axial direction may be less than nine degrees.

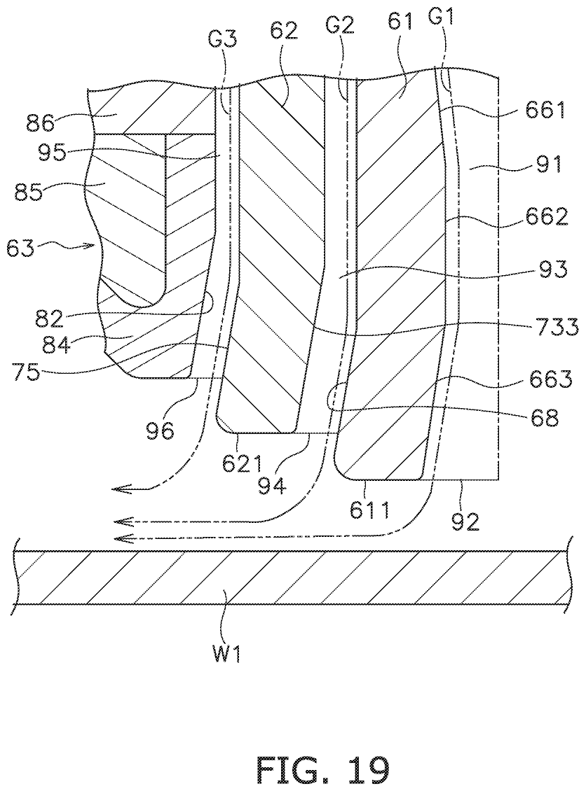

In the embodiment described above, the outer peripheral side of the first distal end portion 68 of the first nozzle 61 extends straight in the axial direction. However, the first distal end portion 68 may slant with respect to the axial direction as configured in a second modification shown in FIG. 19. The first distal end portion 68 may slant to radially expand toward the distal end 611 of the first nozzle 61. Accordingly, the inner shielding gas G2 flows along the first distal end portion 68, and hence, does not easily separate from the first distal end portion 68. For example, the first distal end portion 68 may be identical in slant angle to the second outlet portion 733.

In the embodiment described above, the second distal end portion 75 of the second nozzle 62 extends straight in the axial direction. However, as shown in FIG. 19, the second distal end portion 75 may slant with respect to the axial direction. The second distal end portion 75 may slant to radially expand toward the distal end 621 of the second nozzle 62. Accordingly, the outer shielding gas G3 flows along the second distal end portion 75, and hence, does not easily separate from the second distal end portion 75. For example, the second distal end portion 75 may be identical in slant angle to the third outlet portion 82.

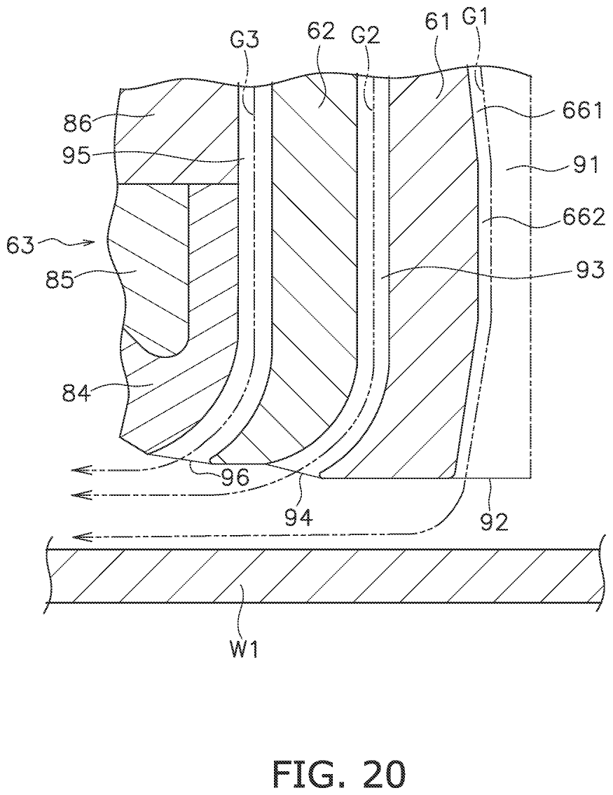

The first to third pathways 91, 93, and 95 are not limited in shape to the embodiment described above and may be changed. For example, the second pathway 93 may be shaped in curve such that the second blowing port 94 faces radially outward as configured in a third modification shown in FIG. 20. The third pathway 95 may be shaped in curve such that the third blowing port 96 faces radially outward. In this case, a reduction is made for the space that the gas reversely flows toward the nozzle unit 6. Accordingly, droplets can be further inhibited from entering the space immediately below the nozzle unit 6.

According to the present invention, it is made possible to effectively inhibit a light blocking liquid from entering a processing range on a workpiece in a laser processing machine. Because of this, the workpiece is enhanced in quality of processing.

1. A nozzle unit for a laser processing machine processing a workpiece disposed in a light blocking liquid with light blocking properties by a laser light, the nozzle unit comprising:
a first nozzle including a first pathway and a first blowing port, the first pathway causing the laser light and an assist gas to pass therethrough, the first blowing port connected to the first pathway, and the first blowing port blowing out the assist gas toward the workpiece;
a second nozzle disposed outside the first nozzle;
a second pathway provided between the first nozzle and the second nozzle, the second pathway causing an inner shielding gas to pass therethrough;
a second blowing port connected to the second pathway, the second blowing port being configured to blow out the inner shielding gas toward the workpiece to remove the light blocking liquid from a space between the first nozzle and the workpiece;
a third nozzle disposed outside the second nozzle;
a third pathway provided between the second nozzle and the third nozzle, the third pathway causing an outer shielding gas to pass therethrough; and
a third blowing port connected to the third pathway, the third blowing port being configured to blow out the outer shielding gas toward the workpiece to remove the light blocking liquid from the space between the first nozzle and the workpiece,
a height of the third blowing port with respect to the workpiece being greater than a height of the second blowing port with respect to the workpiece, and
the height of the second blowing port with respect to the workpiece being greater than a height of the first blowing port with respect to the workpiece.

2. The nozzle unit according to claim 1, wherein
the second nozzle is made of an insulator.

3. The nozzle unit according to claim 1, wherein
the third nozzle includes
a shield with electrical conductivity, and
an insulator covering the shield.

4. The nozzle unit according to claim 1, wherein
the first pathway includes a first outlet portion slanting to radially expand toward the first blowing port.

5. The nozzle unit according to claim 1, wherein
the second pathway includes a second outlet portion slanting to radially expand toward the second blowing port.

6. The nozzle unit according to claim 1, wherein
the third pathway includes a third outlet portion slanting to radially expand toward the second blowing port.

7. The nozzle unit according to claim 1, wherein
the first pathway includes a first outlet portion slanting to radially expand toward the first blowing port,
the second pathway includes a second outlet portion slanting to radially expand toward the second blowing port, and
a slant angle of the second outlet portion with respect to an axial direction of the first nozzle is greater than a slant angle of the first outlet portion with respect to the axial direction.

8. A laser processing machine including the nozzle unit recited in claim 1, the laser processing machine further comprising:
a liquid reservoir configured to store the light blocking liquid;
a mounting stand disposed inside the liquid reservoir to place the workpiece thereon;
a laser generator configured to generate the laser light;
a laser head connected to the laser generator, the laser head disposed above the mounting stand, and the nozzle unit being attached to the laser head; and
a drive device configured to move the laser head.

9. The laser processing machine according to claim 8, further comprising:
a sensor configured to detect a capacitance between the first nozzle and the workpiece; and
a controller configured to
calculate a height of the first nozzle with respect to the workpiece based on the capacitance, and
control the drive device to move the laser head in a height direction.

10. The laser processing machine according to claim 8, wherein
a flow rate of the inner shielding gas blown out from the second blowing port is greater than a flow rate of the outer shielding gas blown out from the third blowing port.

11. The laser processing machine according to claim 8, wherein
a flow rate of the assist gas blown out from the first blowing port is greater than a flow rate of the inner shielding gas blown out from the second blowing port.
